(19) United States
(12) Patent Application Publication
(10) Pub. No.: US 2003/0145256 A1
(43) Pub. Date: Jul. 31, 2003

(54) Error detection device for a multi-voltage vehicle power supply

(76) Inventors: Joerg Jehlicka, Leonberg (DE); Ralf Hadeler, Leonberg (DE)

Correspondence Address: KENYON & KENYON, ONE BROADWAY, NEW YORK, NY, 10004, US

(21) Appl. No.: 10/203,442

(22) PCT Filed: Dec. 5, 2001
(86) PCT No.: PCT/DE01/04563

(30) Foreign Application Priority Data
Dec. 8, 2000 (DE) 100 61 046.3

(51) Int. Cl. H02H 3/05

(52) U.S. Cl. 714/48

(57) ABSTRACT

A device for error detection in a multi-voltage vehicle electrical system is proposed having a power distributor (40) that affects the supply of power to at least one electrical load (46) via at least one output (45), having detection means (41, 42, 44) that detect at least one electrical variable at the output (45), and having at least one signal processing unit (44) that compares the electrical variable (54, 56) to at least one limiting value, the detection of an error state being based on this comparison.

### BACKGROUND INFORMATION

The present invention is based on a device for error detection in a multi-voltage vehicle electrical system according to the definition of the species in the independent claim. In vehicle electrical systems having a plurality of electrical loads, for example, in motor vehicle electrical systems, there exists the problem that a 12-volt voltage is no longer sufficient for electricity supply. Since some of the loads should be provided with a higher voltage than 12 volts, multi-voltage electrical systems that have two different voltage levels are known in the art. There is a first voltage level of +12 volts relative to ground and a second voltage level of +36 volts, each of these voltages being the rated voltage. The connection between the two voltage levels is produced using a d.c.-d.c. converter. This type of multi-voltage electrical system in a motor vehicle is described in German Patent Application 198 45 569. The electrical power is generated in this electrical system using a three-phase alternator that is driven by the vehicle engine and supplies an output voltage of 42 V (charging voltage). A 36-volt (rated voltage) battery is charged using this charging voltage. A 14-volt charging voltage supplies a 12-volt battery via the d.c.-d.c. converter.

The two batteries can have the electrical loads connected to them via the appropriate switch, with the 12-volt battery supplying the traditional electrical system loads, for example, incandescent lamps, while the 36V battery is used to supply high-power loads, such as defrosters. In the known vehicle electrical system, the negative terminals of the two batteries are each connected to the same ground potential. Measures that are used to prevent a short circuit between the 12/14-volt voltage level and the 36/42-volt voltage level are not addressed in German Patent Application 198 45 569.

### ADVANTAGES OF THE INVENTION

The apparatus for error detection in a multi-voltage vehicle electrical system according to the present invention includes a power distributor, which, via at least one output, affects the supply of power to at least one electrical load. Detection means are provided which detect at least one electrical variable at the output. Moreover, at least one signal processing unit is provided that compares the electrical variable to at least one limiting value, error detection being based on this comparison. For the error detection, a setpoint value, for example, with which the electrical load is driven, is used as the limiting value. This advantageously allows the corresponding setpoint and actual values to be compared at defined states and times. Owing to the evaluation, a short circuit or loss of ground connection may be detected. This additional diagnostic function is particularly easy to implement, since the detection means, in any case, are available in the power distributor. Also the setpoint value that is to be applied to the load may easily be made available to the signal processing unit. In this way, either the signal processing unit may itself generate the setpoint value and effect the corresponding drive of the load, or the setpoint value is communicated via a bus system, for example, that is present in either case.

In an expedient further development, the apparatus for error detection is used in a multi-voltage electrical system in a motor vehicle and, in particular, is activated before the vehicle is started. For it has been shown that a large portion of the error cases (short circuit, loss of ground connection) is produced by manipulations on the vehicle while it is at a standstill. Moreover, it is preferable to allow the loads to be driven on their own (apart from the driver's desire) before the motor vehicle is started. The diagnosis that precedes a vehicle startup may initiate appropriate measures to make the user aware of an error condition of the motor vehicle or even prevent him from starting the vehicle. In this way the operational safety of the motor vehicle is increased for the user.

An expedient refinement of the present invention provides for the use of the output voltage as the electrical variable. An output voltage that clearly deviates from zero indicates a short circuit or a loss of ground connection if another electrical load that is also connected to a potential collection point has been activated.

In an expedient refinement, the electrical variable that is detected is the current at the output of the power distributor that was applied to the electrical load connected at the output. In this way a setpoint current of I=0 A is deliberately applied, for example, to the electrical load. The detection means detect the output current, that is the effective actual current, which is applied to the load. When there is a clear deviation between setpoint current and actual current, a short circuit is indicated.

An expedient refinement provides for driving the electrical load using a setpoint current other than zero. If, then, the detected actual current is above the expected range established by the setpoint value, a short circuit is detected; if it is below the expected range, a loss of ground connection is detected. This type of triggering already allows selective pinpointing of a number of sources of error. This improves the diagnostic capability of the system.

Additional expedient refinements arise from additional dependent claims and from the description.

### DRAWING

An exemplary embodiment of the device according to the invention is depicted in the drawing and is explained in detail below.

FIG. 1 shows a theoretical arrangement in a two-voltage vehicle electrical system, FIG. 2 shows a more detailed illustration of the power distributor of FIG. 1, and FIG. 3 shows a flow chart of the error detection procedure.

### DESCRIPTION OF THE EXEMPLARY EMBODIMENT

A first battery 10 having 12-volt nominal voltage is connected between ground 25 and a 14-volt supply branch 26. A 14-volt power distributor 12 is supplied with power via this 14-volt supply branch 26. In the 14-volt power distributor, a voltage clamping device 14, a relay 16, a fuse 18 and a 14-volt-side power semiconductor 20 are electrically conductively connected to 14-volt supply branch 26. Voltage clamping device 14 is in turn connected to ground. Three 14-volt loads, illustrated by way of example, are supplied with electricity via 14-volt power distributor 12. In this way 14-volt loads 22, for example, may be connected to the system via relay 16 or 14-volt-side power semiconductor 20, in that a command fed via a bus system 28 leads to a corresponding triggering operation. 14-volt supply branch 26 is electrically conductively connected via a DC/DC converter 30 to a 42-volt supply branch 38. 42-volt supply branch 38 is supplied with power by a second battery 48, which is connected to ground 25. Second battery 48 preferably has a rated voltage of 36 volts. This second battery 48 may be charged via a generator 50 that is connected in parallel. A 42-volt power distributor 40 is used for the load distribution for 42-volt load 46. The 42-volt supply voltage is fed on one side via 42-volt supply branch 38 to 42-volt power distributor 40. On the other side, 42-volt power distributor 40 is connected to bus system 28 for data exchange. A first and second power semi-conductor 41, 42, which may each connect 42-volt load 46 to 42-volt potential, are depicted by way of example in 42-volt power distributor 40. Both power semiconductors 41, 42 have an inverse diode 43. A micro-controller 44 controls power semiconductors 41, 42. Micro-controller 44 receives currents I1, I2 flowing through and sensed by power semi-conductors 41, 42 at outputs 45. Moreover, each of potentials or voltages U1, U2 present on outputs 45 are fed to micro-controller 44. 42-volt loads 45 are electrically conductively connected on one side to outputs 45 of 42-volt power distributor 40 and on the other side to a potential collection point 24. 14-volt loads 22 also make contact with this potential collection point 24. However, as indicated by the lightning symbol, there is an error, which is that there is no electrical connection between potential collection point 24 and ground potential 25. This fault scenario is referred to below as “loss of ground connection”. As another fault scenario, a short circuit between one of the 14-volt loads 22 and one of the 42-volt loads 46 is sketched using short-circuit impedance 32. In this depicted fault scenario, an increased voltage level of approximately 24 volts would be set for the 14-volt supply branch of 14-volt power distributor 12 because of inverse diode 21 of 14-volt-side power semiconductor 20. Moreover, the state of an ignition contact switch 34 and a door contact switch 36 may be provided via bus system 28.

In FIG. 2, the theoretical structure of 42-volt power distributor 40 is shown more in more detail. It includes micro-controller 44, which exchanges data via a bus system 28. Moreover, a voltage of 42 volts is fed via 42-volt supply branch 38 to first power semiconductor 41. First power semiconductor 41 is controlled by micro-controller 44 via a first drive signal 51. Power semiconductor 41, which is, for example, a sense FET, supplies the actual current value 54 that is applied to power semiconductor 41 for driving 42-volt load 46. Moreover, actual voltage value 56, which is present at output 45, is fed to micro-controller 44. Furthermore, micro-controller 44 produces a second drive signal 52, with which a switching means 60 in the immediate vicinity of load 46 may be activated or deactivated. The electrical load 46 in the exemplary embodiment is an electric motor 58. The 42-volt load is connected to potential collection point 24.

The mode of operation of the device for error detection in a multi-voltage electrical system of a motor vehicle is described in closer detail below in connection with FIG. 3. It is assumed that the motor vehicle is found in a normal parked state. A user would then like to initiate the startup of the motor vehicle. The opening of the door when the driver enters the vehicle is sensed by door contact switch 36. The output signal of door contact switch 36 may then be fed, for example via bus system 28, to the 42-volt power distributor in order to switch micro-controller 44 of the 42-volt power distributor from standby mode into normal operating mode. In addition, the error detection procedures described below are carried out during the ramp-up of 42-volt power distributor 40. Instead of the door contact switch, the “Ignition on” signal that is supplied by ignition contact switch 34 could also be used, for example.

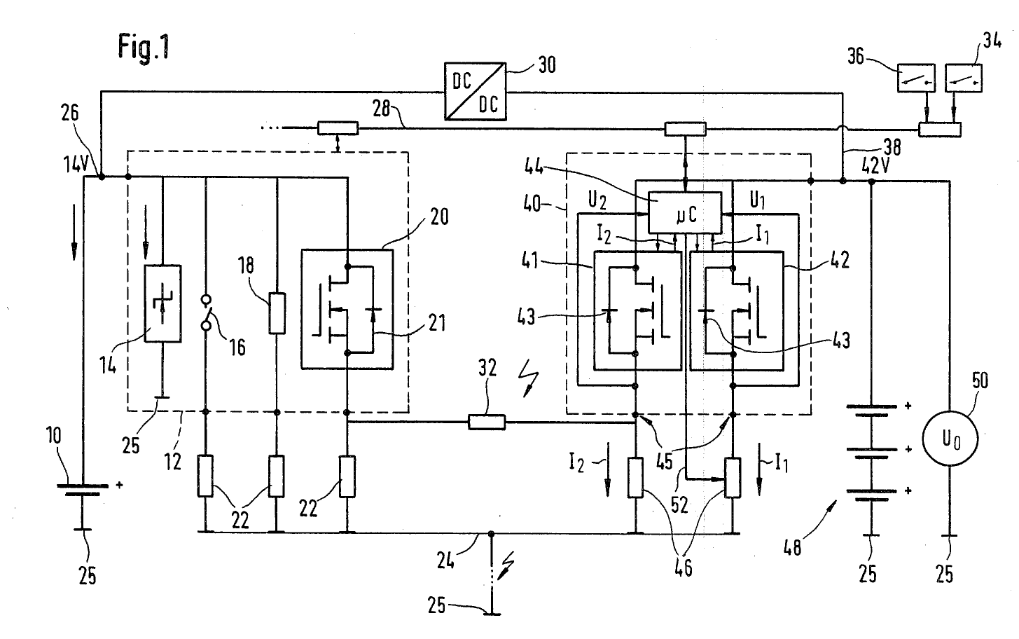

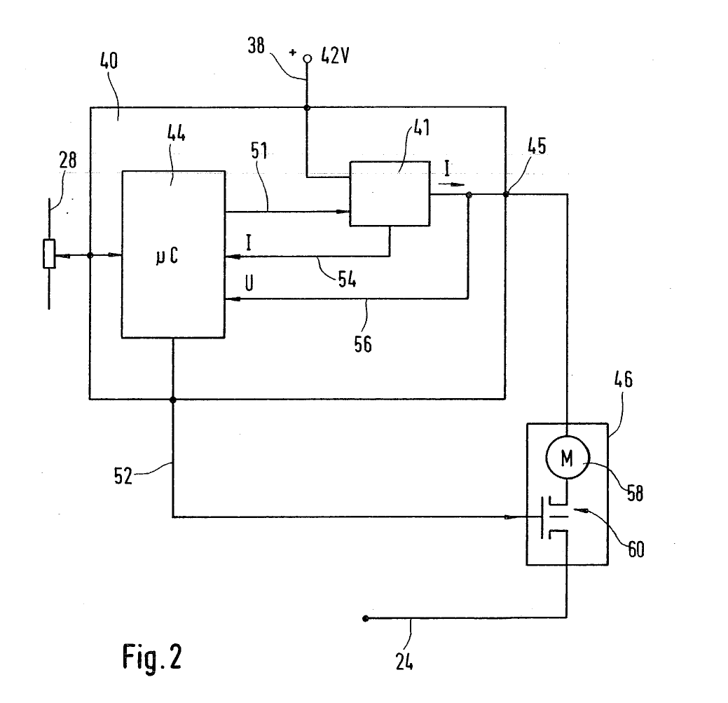

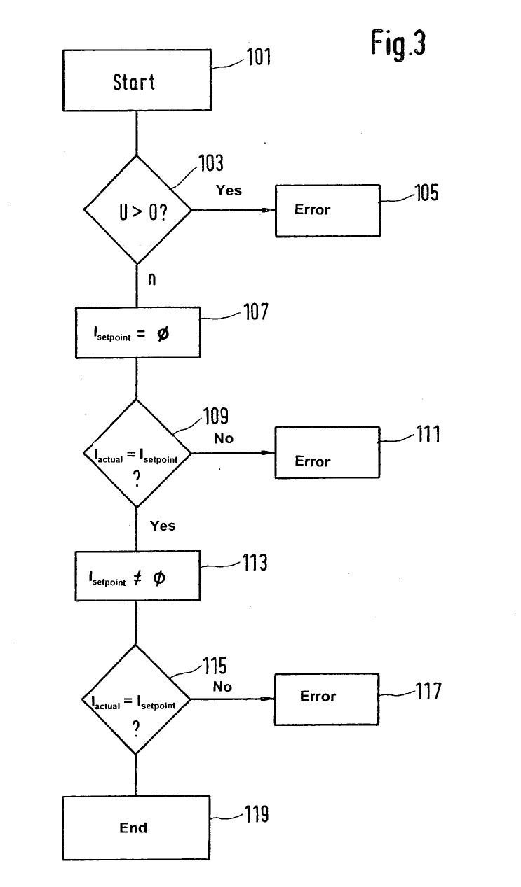

When the described activation of the error detection occurs (Step 101), micro-controller 44 detects actual voltage value 56 at output 45 before first power semiconductor 41 switches on 42-volt load 46. Micro-controller 44 determines whether voltage actual value 54 clearly deviates from zero (Step 103). Then a fault is indicated (Step 105). However, a voltage actual value 46 that clearly deviates from zero will only be set if a 14-volt load 22 has already been activated. For a voltage 56 that deviates from zero, there may be two fault situations. Either it is a short circuit, as indicated in FIG. 1 by short circuit impedance 32, or potential collection point 24 and ground potential 25 are no longer electrically conductively connected (loss of ground connection). When an actual voltage value 56 clearly deviates from zero, micro-controller 44 in Step 105 generates an error message that arrives via the bus system 28 at a display (not shown). Furthermore, the startup operation of the motor vehicle could also be prevented.

In a second test routine, micro-controller 44 then causes a current setpoint value ISETPOINT=0, which corresponds to the second drive signal, to be applied to 42-volt load 46 (Step 107). Power semiconductors 41, 42 are activated in the process and receive a corresponding first drive signal 51, i.e., are switched on. In the exemplary embodiment of FIG. 2, 42-volt load 46 may be externally activated in the desired manner via switching means 60. Illustrated by way of example, micro-controller 44 itself produces this current setpoint value ISETPOINT=0 and forwards it in the form of second drive signal 52 to switching means 60. Then, micro-controller 44 detects the current actual value 54 that is set on output 45. This actual current value 54 may, for example, be provided by electrical semiconductor 41, which is a sense FET. Micro-controller 44 compares detected actual current value 54 with the second drive signal 52, specified current setpoint value ISETPOINT=0 (Step 109). If current actual value 54 and second drive signal 52 (current setpoint value ISETPOINT) deviate significantly from each other, then this indicates the presence of a short circuit. Power distributor 40 switches off the supply of 42-volt load 46 via the first power semiconductor 41 (Step 111). As already described, micro-controller 44 produces an error message and initiates the corresponding countermeasures.

In a third error detection procedure, 42-volt load 46 is brought into a defined state (Step 113). Micro-controller 44, for example, specifies a current setpoint value ISETPOINT that assumes a value other than zero. 42-volt load 46, in turn, is switched on via first power semiconductor 41. Second drive signal 52 is selected so that setpoint value ISETPOINT is set. In this, a pulse-width-modulated drive, for example, of switching means 60 may be provided. Setpoint value ISETPOINT in the process determines the pulse width of drive signal 52. Actual current value 54, which is set with this drive, is detected by micro-controller 44 and compared to the current setpoint value ISETPOINT or second drive signal 52 (Step 115). If current actual value 54 lies significantly above the expected range, i.e. above the current setpoint value ISETPOINT, a short circuit is detected (Step 117). If, on the other hand, current actual value 54 lies clearly below the current setpoint value, ISETPOINT, then a loss of ground contact is indicated (Step 117). For when there is no connection between potential collection point 24 and ground potential 25, the current also still flows through 14-volt load 22 via the inverse diode of 12-volt-side power semiconductor 20. In this way a different actual current value 54 is set that is lower than the current that would normally drain off to ground 25. Also in these two fault scenarios of the third error detection procedure, micro-controller 44 causes the immediate shutoff of first power semiconductor 41 via a corresponding input of first drive signal 51.

If 42-volt load 46 cannot be externally driven via a switching means 60, then micro-controller 44 causes the activation of load 46 and compares actual current value 54 being set in the process to an expected current value stored in advance in micro-controller 44. The error detection arises from this comparison in accordance with the previously described third procedure.

The proposed concept may also be applied for diagnosis during vehicle operation. Thus, there is a comparison at all times as to whether actual current value 46 lies within the expected range. For normal loads 46, the setpoint current may be estimated relatively easily. For externally controllable loads 46, on the other hand, the expected range may be limited if the drive information (setpoint value) is known.

What is claimed is:

1. A device for error detection in a multi-voltage vehicle electrical system having a power distributor (40) that affects the supply of power to at least one electrical load (46) using at least one switching means (41, 42), having detection means (41, 42, 44) that detect at least one electrical variable (54, 56) that is applied to the electrical load (46), and having at least one signal processing unit (44) that compares the electrical variable (54, 56) to at least one limiting value, the detection of an error state (105, 111, 117) being a function of this comparison,
wherein the signal processing unit (44) detects an error by comparing at least one setpoint value (52) that is applied to the electrical load (46) or an expected value, to the electrical variable (54, 56) for the detection of the error state.

2. The device as recited in one of the preceding claims, wherein the signal processing unit (44) drives the switching means (41, 42).

3. The device as recited in one of the preceding claims, wherein the signal processing unit (44) drives the switching means (41, 42) in the open state and detects the voltage (56) present at the output (45) as the electrical variable.

4. The device as recited in one of the preceding claims, wherein the signal processing unit (44) drives the switching means (41, 42) to close them and detects the actual current value (54) as the electrical variable.

5. The device as recited in one of the preceding claims, wherein a setpoint current (52) of zero is applied to the electrical load (46) and the signal processing unit (44) compares the actual current value (54) to the setpoint current (52) for the error detection.

6. The device as recited in one of the preceding claims, wherein a setpoint current (52) other than zero is applied to the electrical load (46) and the signal processing unit (44) compares the actual current value (54) to the setpoint current (52) for the error detection.

7. The device as recited in one of the preceding claims, wherein the signal processing unit (44) produces the setpoint value for driving the electrical load (46).

8. The device as recited in one of the preceding claims, wherein the power distributor (44) is mounted in a motor vehicle.

9. The device as recited in one of the preceding claims, wherein the signal processing unit (44) is activated as a function of a switching signal of a switch (34, 36).

10. The device as recited in one of the preceding claims, wherein a door contact switch (36) or ignition starter switch (34) is used as the switch.
